(19) United States
(12) Patent Application Publication
(10) Pub. No.: US 2015/0142444 A1
(43) Pub. Date: May 21, 2015

(54) AUDIO RENDERING ORDER FOR TEXT SOURCES

(71) Applicant: International Business Machines Corporation, Armonk, NY (US)

(72) Inventors: Gregory Jensen Boss, Saginaw, MI (US); Andrew R. Jones, Round Rock, TX (US); Charles Steven Lignafelt, Research Triangle Park, NC (US); Kevin C. McConnell, Austin, TX (US); John Elbert Moore, JR., Indianapolis, IN (US)

(73) Assignee: International Business Machines Corporation, Armonk, NY (US)

(21) Appl. No.: 14/080,821

(22) Filed: Nov. 15, 2013

(51) Int. Cl. G10L 13/08; G10L 13/04

(52) U.S. Cl. CPC G10L 13/08; G10L 13/04
USPC 704/260

(57) ABSTRACT

A method includes loading text content into at least one user device; applying at least one reading order to at least one text section of the text content to change a presentation order; converting the at least one text section to an audio output based upon the presentation order; and playing the audio output using the presentation order on the at least one user device.

### BACKGROUND

The present invention relates to converting text sources to audio and more specifically, to playing the text to audio output using read orders.

### SUMMARY

According to one aspect of the present invention, a method includes loading text content into at least one user device; applying at least one reading order to at least one text section of the text content to change a presentation order; converting the at least one text section to an audio output based upon the presentation order; and playing the audio output using the presentation order on the at least one user device.

According to another aspect of the present invention, a computer system includes one or more processors, one or more computer-readable memories and one or more computer-readable, tangible storage devices; a loading module operatively coupled to at least one of the one or more storage devices for execution by at least one of the one or more processors via at least one of the one or more memories, configured to load text content into at least one user device; a read order module operatively coupled to at least one of the one or more storage devices for execution by at least one of the one or more processors via at least one of the one or more memories, configured to apply at least one reading order to at least one text section of the text content to change a presentation order; a conversion module operatively coupled to at least one of the one or more storage devices for execution by at least one of the one or more processors via at least one of the one or more memories, configured to convert the at least one text section to an audio output based upon the presentation order; and an audio output module operatively coupled to at least one of the one or more storage devices for execution by at least one of the one or more processors via at least one of the one or more memories, configured to play the audio output using the presentation order on the at least one user device.

According to yet another aspect of the present invention, a computer program product including: one or more computer-readable, tangible storage medium; program instructions, stored on at least one of the one or more storage medium, to load text content into at least one user device; program instructions, stored on at least one of the one or more storage medium, to apply at least one reading order to at least one text section of the text content to change a presentation order; program instructions, stored on at least one of the one or more storage medium, to convert the at least one text section to an audio output based upon the presentation order; and program instructions, stored on at least one of the one or more storage medium, to play the audio output using the presentation order on the at least one user device.

### BRIEF DESCRIPTION OF THE SEVERAL VIEWS OF THE DRAWINGS

FIG. 1 shows a flowchart according to an embodiment of the present invention.

FIG. 2 shows an exemplary implementation according to an embodiment of the present invention.

FIG. 3 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

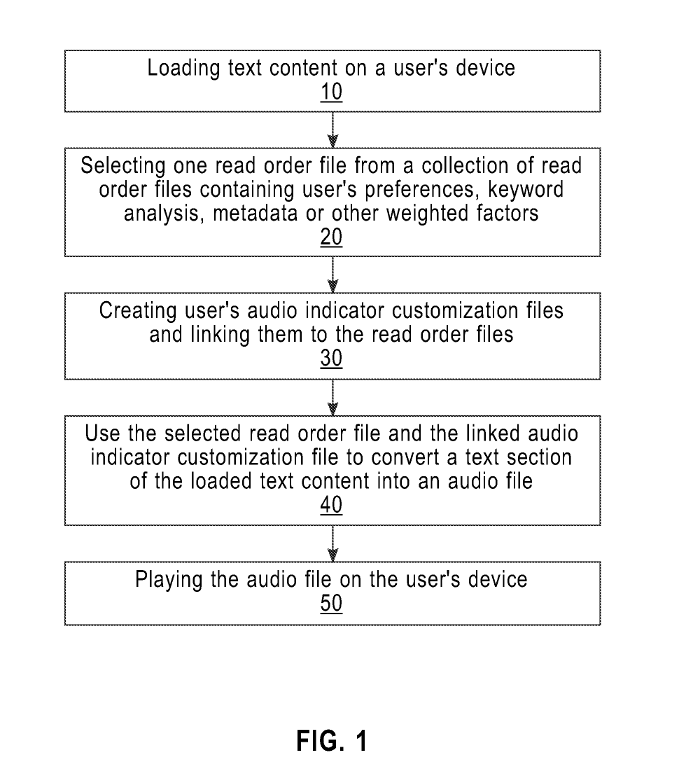

Now referring to FIG. 1, an embodiment of the present invention optimizes the audiozation of content on a web page, by utilizing a read order file which contains instructions for the order to read page elements for a web page (e.g., start with biggest frame that is at least ⅕ way down from top and ¼ over from side, read any pop ups or ads that are in a right side frame last) and linking this with audio indicators to convey to the user the type of page and the specific elements on the page. A process for producing the audio order rending starts with loading web page text content on a user's device (10). Then a read order file is selected from a collection of read order files containing the user's preferences (20). The preferences may include keyword(s) analysis, web page metadata or other weighed factors such as web page tags or URL domains. One example of a software module could use the following selection methods:

Selection Based on Web Page Tags
If web page type=news then select Read Order file with type=news
if web page type=sports then select Read Order file with type=sports
if web page type=weather, then select Read Order file with type=weather

Selection Based on Web Page URL
if web page base URL=.CNN then select Read Order file for online_news
if web page base URL=Google then select Read Order file for google
if web page base URL=Gov, then select Read Order file for governmental web sites

Other selection methods for the read order files may include:
Select web elements based on size wherein for each frame on web page determine the size of each frame, e.g. square inches or count of the number of pixels or percentage of the display. For each web page frame, place size of frame into a list. Based on the size order specified in Read Order file, create an ordered list of web page frames
Select web elements based on location coordinates in the read order file. For each location coordinates specified in the read order file, identify the web page frame's order and place this frame in the correct location of the ordered list.
Select web elements by applying weighting factors on the web page. For each frame of web text, apply weighing factor defined within the Read Order file for a frame and create an ordered list of frames, based on these weighing factor.

Still referring to FIG. 1, the process continues by creating user's audio indicator customization files and linking them to the read order files (30). Indicator customization files may include but not limited thereto: 2 beeps for a news type of page, a train whistle for a page from a .GOV domain, a low tone for table elements or a waterfall sound for paragraph text. In an alternate embodiment the indicator customization files may use a natural audio voice output for identifying the text paragraph. The process then uses the selected read order file and the linked audio indicator customization file to convert a text section of the loaded text content into an audio file (40). The process ends with the playing of the audio file on the user's device (50).

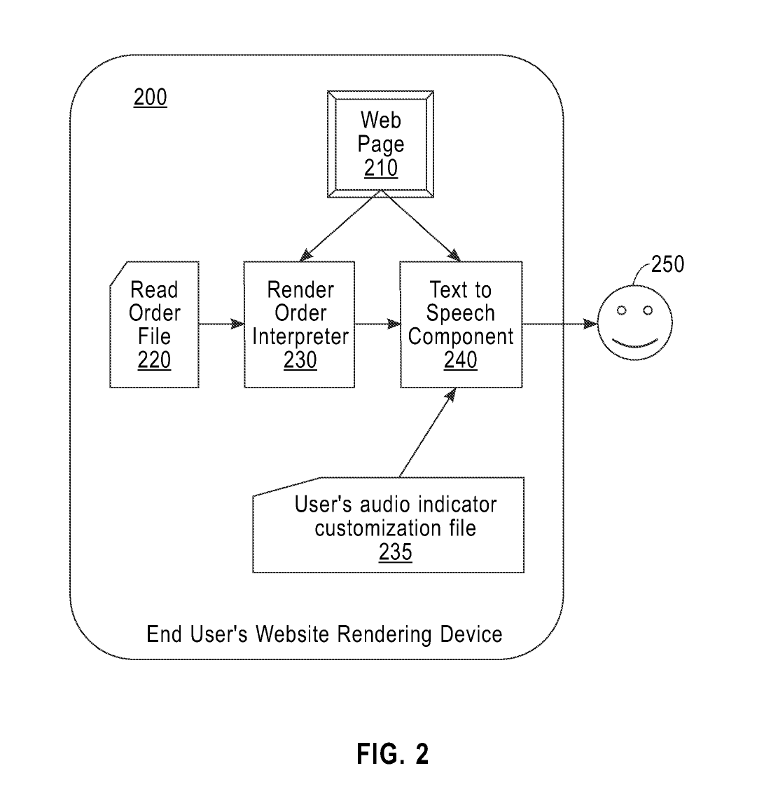

Referring to FIG. 2, an exemplary implementation according to an embodiment of the present invention is depicted. A user's device 200 displays a loaded web page 210. Once the web page 210 is loaded a read order file 220 is loaded into a render order interpreter 230. The web page 210 data is loaded into both the render order interpreter 230 and a text to speech component 240. A user's audio indicator customization file 235 is also feed into the text to speech component 240. As described with reference to the process of FIG. 1, the text to speech component 240 takes the web page 210 data and reorders the text data in response to the read order file 220 and the user's audio indicator customization file 235. Once the text data is reorderd, the text to speech component 240 the converts the text to audio for a user 250 to hear. The user's device 200 may include either speakers for playing the audio output or has an ear jack for playing the audio through personal earphones.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

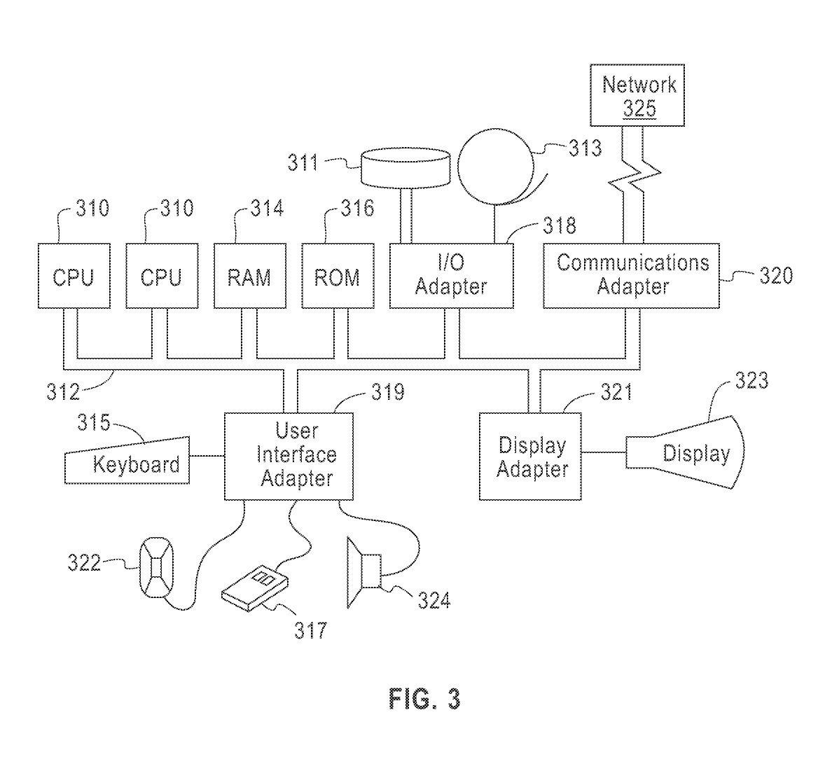

Referring now to FIG. 3, this schematic drawing illustrates a hardware configuration of an information handling/computer system in accordance with the embodiments of the invention. The system comprises at least one processor or central processing unit (CPU) 310. The CPUs 310 are interconnected via system bus 312 to various devices such as a random access memory (RAM) 314, read-only memory (ROM) 316, and an input/output (I/O) adapter 318. The I/O adapter 318 can connect to peripheral devices, such as disk units 311 and tape drives 313, or other program storage devices that are readable by the system. The system can read the inventive instructions on the program storage devices and follow these instructions to execute the methodology of the embodiments of the invention. The system further includes a user interface adapter 319 that connects a keyboard 315, mouse 317, speaker 324, microphone 322, and/or other user interface devices such as a touch screen device (not shown) to the bus 312 to gather user input. Additionally, a communication adapter 320 connects the bus 312 to a data processing network 325, and a display adapter 321 connects the bus 312 to a display device 323 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
loading text content into at least one user device;
applying at least one reading order to at least one text section of the text content to change a presentation order;
converting the at least one text section to an audio output based upon the presentation order; and
playing the audio output using the presentation order on the at least one user device.

2. The method according to claim 1, wherein the at least one reading order is predefined using a user's criteria selection.

3. The method according to claim 1, wherein the at least one reading order is defined by the at least one text section.

4. The method according to claim 1, further comprising linking at least one user's audio customization file to the at least one reading order.

5. The method according to claim 4, wherein the conversion of the at least one text to the audio output uses the user's audio customization file.

6. The method according to claim 2, wherein the user's criteria selection is based on the size of the at least one text section.

7. The method according to claim 2, wherein the user's criteria selection is based on the location of the at least one text section.

8. A computer system comprising:
one or more processors, one or more computer-readable memories and one or more computer-readable, tangible storage devices;
a loading module operatively coupled to at least one of the one or more storage devices for execution by at least one of the one or more processors via at least one of the one or more memories, configured to load text content into at least one user device;
a read order module operatively coupled to at least one of the one or more storage devices for execution by at least one of the one or more processors via at least one of the one or more memories, configured to apply at least one reading order to at least one text section of the text content to change a presentation order;
a conversion module operatively coupled to at least one of the one or more storage devices for execution by at least one of the one or more processors via at least one of the one or more memories, configured to convert the at least one text section to an audio output based upon the presentation order; and
an audio output module operatively coupled to at least one of the one or more storage devices for execution by at least one of the one or more processors via at least one of the one or more memories, configured to play the audio output using the presentation order on the at least one user device.

9. The system according to claim 8, wherein the at least one reading order is predefined using a user's criteria selection.

10. The system according to claim 8, wherein the at least one reading order is defined by the at least one text section.

11. The system according to claim 8, further comprising a linking module operatively coupled to at least one of the one or more storage devices for execution by at least one of the one or more processors via at least one of the one or more memories, configured to link at least one user's audio customization file to the at least one reading order.

12. The system according to claim 11, wherein the conversion of the at least one text to the audio output uses the user's audio customization file.

13. The system according to claim 9, wherein the user's criteria selection is based on the size of the at least one text section.

14. The system according to claim 9, wherein the user's criteria selection is based on the location of the at least one text section.

15. A computer program product comprising:
one or more computer-readable, tangible storage medium;
program instructions, stored on at least one of the one or more storage medium, to load text content into at least one user device;
program instructions, stored on at least one of the one or more storage medium, to apply at least one reading order to at least one text section of the text content to change a presentation order;
program instructions, stored on at least one of the one or more storage medium, to convert the at least one text section to an audio output based upon the presentation order; and
program instructions, stored on at least one of the one or more storage medium, to play the audio output using the presentation order on the at least one user device.

16. The computer program product according to claim 15, wherein the at least one reading order is predefined using a user's criteria selection.

17. The computer program product according to claim 15, wherein the at least one reading order is defined by the at least one text section.

18. The computer program product according to claim 15, further includes program instructions, stored on at least one of the one or more storage medium, to link at least one user's audio customization file to the at least one reading order.

19. The computer program product according to claim 16, wherein the user's criteria selection is based on the size of the at least one text section.

20. The computer program product according to claim 16, wherein the user's criteria selection is based on the location of the at least one text section.
